(19) United States
(12) Patent Application Publication
(10) Pub. No.: US 2026/0323181 A1
(43) Pub. Date: Oct. 15, 2026

(54) IMAGING APPARATUS AND IMAGING DISPLAY APPARATUS

(71) Applicant: CANON KABUSHIKI KAISHA, Tokyo (JP)

(72) Inventor: TAKEAKI ITSUJI, Kanagawa (JP)

(21) Appl. No.: 19/637,783

(22) Filed: Apr. 2, 2026

(30) Foreign Application Priority Data
Apr. 9, 2025 (JP) 2025-064214

(51) Int. Cl. H04N 25/77; G02B 13/06; H04N 7/01; H04N 13/383; H04N 13/398

(52) U.S. Cl. CPC H04N 25/77; H04N 7/0127; H04N 13/383; H04N 13/398; G02B 13/06

(57) ABSTRACT

An apparatus includes a lens unit having a first region corresponding to an angle of view greater than an angle of view θₐ and a second region corresponding to an angle of view equal to or smaller than the angle of view θₐ, wherein a change amount in image height in the second region is larger than a change amount in image height in the first region, and an imaging unit including a sensor substrate having a plurality of pixels each including an avalanche diode, on which light from the lens unit is incident, and a pixel circuit substrate that outputs pixel signals of the plurality of pixels.

### BACKGROUND

### Field of the Technology

The aspect of the embodiments relates to an imaging apparatus and an imaging display apparatus. In particular, the aspect of the embodiment relates to head-mounted display technology.

### Description of the Related Art

As one form of an imaging display apparatus, Japanese Patent Laid-Open No. 2020-167600 discloses a head-mounted display having a fish-eye lens for acquiring an image having a wide angle of view and an image sensor. As another form of an imaging display apparatus, Japanese Patent Laid-Open No. 2024-121777 discloses smart glasses having a photoelectric conversion device, an OLED (Organic Light Emitting Diode) display apparatus, and a lens.

In general, an image sensor for use in an imaging display apparatus may be a CMOS (Complementary Metal Oxide Semiconductor) sensor. Alternatively, the image sensor may be an SPAD (Single Photon Avalanche Diode) sensor. These sensors each have a lower limit for photon detection.

Because of the lower limit for photon detection by the image sensor, as ambient illuminance decreases, a lower limit of the pixel pitch of the image sensor increases. The lower limit of the pixel pitch may suppress the resolution of the imaging display apparatus. Therefore, such a trade-off relationship between ambient illuminance and resolution may limit use cases of an imaging display apparatus and an imaging apparatus for use in the imaging display apparatus.

### SUMMARY

According to some embodiments, an apparatus includes a lens unit having a first region corresponding to an angle of view greater than an angle of view θₐ and a second region corresponding to an angle of view equal to or smaller than the angle of view θₐ, wherein a change amount in image height in the second region is larger than a change amount in image height in the first region, and an imaging unit including a sensor substrate having a plurality of pixels each including an avalanche diode, on which light from the lens unit is incident, and a pixel circuit substrate that outputs pixel signals of the plurality of pixels, wherein when a maximum angle of view of the lens unit is θₘₐₓ, a focal length is f, and an image height at an angle of view, which is one half of the maximum angle of view θₘₐₓ, is y(θₘₐₓ/2), the following expression (1) is satisfied:

$$1 < \frac{f \times sin \frac{{θ}_{max}}{2}}{y ( \frac{{θ}_{max}}{2} )} \qquad ( 1 )$$

Features of the disclosure will become apparent from the following description of embodiments with reference to the attached drawings. The following description of embodiments is described by way of example.

### BRIEF DESCRIPTION OF THE DRAWINGS

FIGS. 1A and 1B illustrate an exemplary configuration of a head-mounted display according to a first embodiment.

FIG. 2 illustrates an example of projection characteristics of a lens unit according to the first embodiment.

FIG. 3 illustrates an example of resolution of the lens unit according to the first embodiment and of a normal lens.

FIG. 4 is a view illustrating an exemplary configuration of an image sensor according to the first embodiment.

FIG. 5 is a diagram illustrating an exemplary configuration of a pixel circuit substrate according to the first embodiment.

FIG. 6 is a diagram illustrating an exemplary configuration of a charge processing unit according to the first embodiment.

FIG. 7 illustrates an example of the angular pixel density of a head-mounted display according to Example 1.

FIG. 8 illustrates an example of the angular pixel density of a head-mounted display according to Example 2.

FIG. 9 is a diagram illustrating an exemplary configuration of the head-mounted display according to a second embodiment.

FIG. 10 is a chart illustrating an operation example of a video signal conversion unit according to the second embodiment.

FIG. 11 is a diagram illustrating an exemplary configuration of a head-mounted display according to a third embodiment.

FIG. 12 is a diagram illustrating an exemplary configuration of a head-mounted display according to a fourth embodiment.

FIG. 13 is a diagram illustrating an exemplary configuration of a head-mounted display according to a fifth embodiment.

FIG. 14 illustrates an exemplary relationship between pixel pitch and the number of photon detections in an image sensor.

### DESCRIPTION OF THE EMBODIMENTS

The following embodiments are provided merely to illustrate the technical concept of the present disclosure and are not intended to limit the technology of the present disclosure. Sizes and positional relationships of members shown in the drawings are not necessarily drawn to scale for clarity of illustration. In the following description, the same components are denoted by the same reference numerals, and detailed description thereof may not be provided.

The present disclosure relates to an imaging apparatus and an imaging display apparatus using the imaging apparatus. For example, the imaging apparatus may be a camera device or a video camera device. For example, night vision goggles or a head-mounted display may be applied as an imaging display apparatus. In particular, a head-mounted display will be described as an example of the imaging display apparatus according to an embodiment of the present disclosure. A camera system built in a head-mounted display will be described as an example of the imaging apparatus. Specifically, the embodiments described below relate to a head-mounted display adapted for use in a low-illuminance environment, for the purpose of expanding use cases of the head-mounted display. The devices to which the embodiments may be applied are not limited to the above.

The head-mounted display of the present disclosure is a video see-through type head-mounted display including at least a stereo camera configuration. For example, in the following embodiments, low illuminance refers to an ambient illuminance in a range of 10 mlx to 100 mlx. In general, a human visual field is divided into a central visual field, which can be viewed with high resolution, an effective visual field, which can be viewed by eye movement, and a peripheral visual field, in which shapes and colors of objects cannot be clearly distinguished. In the present disclosure, it is assumed that the central visual field has an angle of view of 10 degrees, the effective visual field has an angle of view of 60 degrees, and the peripheral visual field has an angle of view of 120 degrees.

The head-mounted display of the present disclosure provides a user with video of a peripheral visual field in a low illuminance environment and provides, at least in an effective visual field region, a resolution that does not impair user workability. In the following embodiments, an angular pixel density of 20 ppd is assumed as a resolution level that does not impair user workability. This angular pixel density corresponds to an angular pixel density when video of the peripheral visual field is provided to the user by a so-called 2K-by-2K display panel. Note that this angular pixel density value is a typical example, and the angular pixel density applicable in each embodiment is not limited to this value.

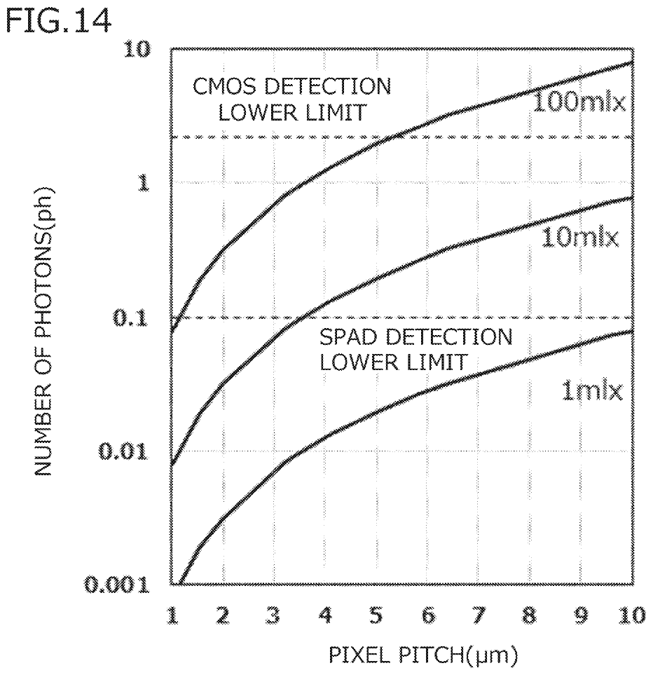

FIG. 14 illustrates an exemplary relationship between pixel pitch of an image sensor and the number of photons detected by pixels when a wide-angle imaging lens is used in an imaging apparatus. As shown in the graph of FIG. 14, the number of detected photons and a lower limit for photon detection vary depending on an imaging lens or an exposure time (frame rate). Relative relationships are substantially the same for a CMOS sensor and an SPAD sensor. The present disclosure provides technology for securing required resolution even under reduced ambient illuminance, in an imaging apparatus and an imaging display apparatus using the imaging apparatus.

### First Embodiment

A configuration of a head-mounted display according to a first embodiment will be described with reference to the drawings.

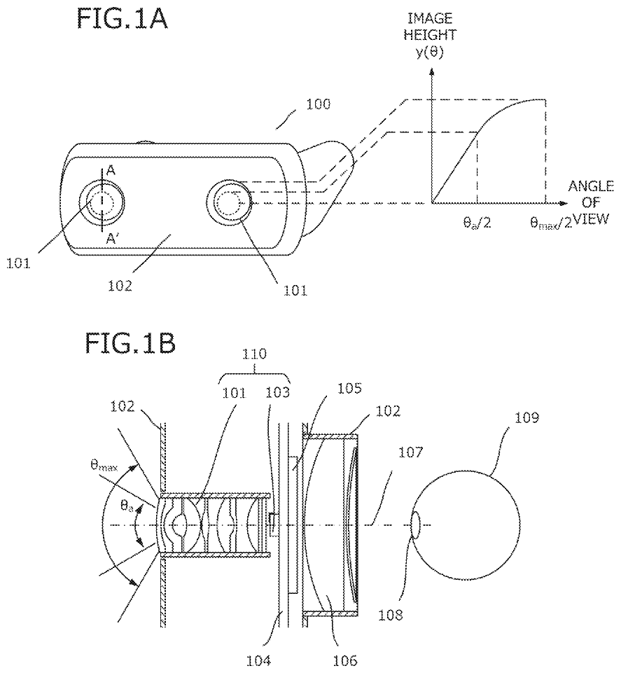

FIG. 1A illustrates a configuration of a part of the head-mounted display. FIG. 1B is a cross-sectional view of the head-mounted display 100 taken along line A-A′ in FIG. 1A. The head-mounted display 100 includes a lens unit 101 and a housing 102. The lens unit 101 includes a low-resolution region, which is a first region having an angle of view greater than θₐ, and a high-resolution region, which is a second region having an angle of view equal to or smaller than θₐ. With respect to a change amount of an image height y(θ) of the lens unit 101 relative to the angle of view, the change amount in the high-resolution region is set to be greater than the change amount in the low-resolution region.

The head-mounted display 100 includes an image sensor 103 and a display panel 105. The image sensor 103 and the display panel 105 are arranged on a substrate 104. The substrate 104 may include circuits for driving the image sensor 103 and the display panel 105. The substrate 104 may also include a plurality of substrates.

The lens unit 101 projects an image of an object outside of the head-mounted display 100 onto the image sensor 103. The head-mounted display 100 according to the embodiment includes a camera system 110 including the lens unit 101 and the image sensor 103.

The head-mounted display 100 also includes a display optical unit 106. Video displayed by the display panel 105 is formed on the retina of the eyeball 109 via the display optical unit 106 and the pupil 108 of a user, thereby presenting a virtual image to the user. Specifically, the display panel 105 displays video based on an image acquired by an imaging unit.

In order to reduce a sense of discomfort a user feels with respect to video displayed on the display panel 105, parallax videos are preferably projected onto the left and right eyeballs 109 of the user. In order to acquire parallax video, a plurality of imaging units are preferably provided. For example, some of the plurality of imaging units are preferably arranged in a stereo camera configuration in which the lens unit 101, the image sensor 103, and the eyeballs 109 are aligned along an optical axis 107. More preferably, a center of the display panel 105 and the display optical unit 106 are aligned along the optical axis 107.

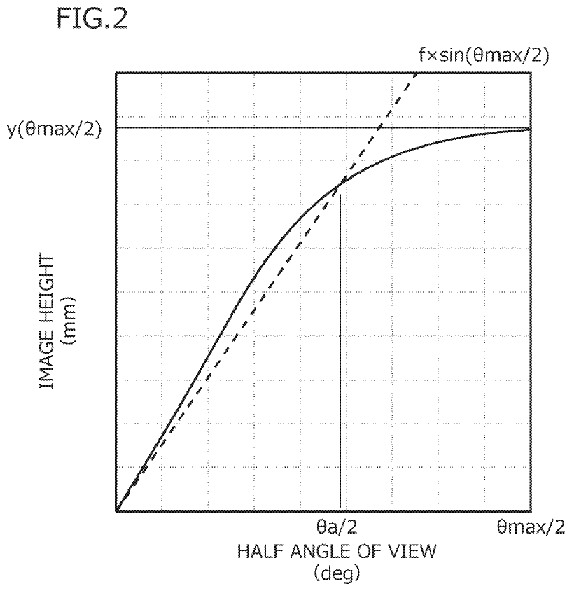

FIG. 2 illustrates projection characteristics of the lens unit 101, showing a relationship between a half angle of view of a lens and an image height. A lens for acquiring an image having an angle of view assumed in the present embodiment may be for example a fisheye lens, which is a type of wide-angle lens. In the present embodiment, a wide-angle lens including a fisheye lens may also be referred to as a normal lens.

Projection characteristics of a normal lens can be expressed as f sin(θ/2), where f represents the focal length of the lens and θ/2 represents a half angle of view. By distorting an image on a wide-angle side, a wide-angle image can be acquired. In general, in a normal lens, when an image height at the half angle of view θ/2 is denoted by y(θ/2), characteristics of the lens can be expressed by the following expression (1):

$$\frac{f \times sin \frac{θ}{2}}{y ( \frac{θ}{2} )} \leq 1 \qquad ( 1 )$$

Meanwhile, the lens unit 101 according to the present embodiment has projection characteristics in which an image height characteristic larger than that of a normal lens is exhibited in an angle-of-view range equal to or smaller than θₐ (high-resolution region), and an image height characteristic smaller than that of a normal lens is exhibited in an angle-of-view range greater than θₐ (low-resolution region). When a maximum angle of view of the lens unit 101 is denoted by θₘₐₓ and an image height at a half angle of view θₘₐₓ is denoted by y (θₘₐₓ/2), characteristics of the lens unit 101 satisfy the following expression (2):

$$1 < \frac{f \times sin \frac{{θ}_{max}}{2}}{y ( \frac{{θ}_{max}}{2} )} \qquad ( 2 )$$

When a lens is designed to obtain the same image height at the maximum angle of view θₘₐₓ, the expression (2) allows the lens unit 101 to select a focal length larger than that of a normal lens. By increasing the focal length, resolution in the high-resolution region can be more easily increased than the case of a fisheye lens, which is a normal lens.

The lens unit 101 having the characteristics is disclosed in, for example, Japanese Patent Laid-Open No. 2024-78751. The problem to be solved by technology in Japanese Patent Laid-Open No. 2024-78751 is to reduce processing delay time caused by distortion correction processing required when a fisheye lens, which is a normal lens, is used. In order to solve this problem, Japanese Patent Laid-Open No. 2024-78751 discloses a design example of a lens unit having two regions, i.e., a high resolution region and a low resolution region. Japanese Patent Laid-Open No. 2024-78751 also discloses an apparatus configuration capable of acquiring a wide-angle image that is sufficiently recognizable without distortion correction processing.

The problems to be solved in the present embodiment and the problems in Japanese Patent Laid-Open No. 2024-78751 are different from each other. However, in the embodiment, in order to provide a head-mounted display that secures high resolution even under reduced ambient illuminance without sacrificing an angle of view, a lens unit having a high-resolution region and a low-resolution region is incorporated into the head-mounted display.

As disclosed in Japanese Patent Laid-Open No. 2024-78751, a ratio θₐ/θₘₐₓ, which is the ratio between an angle of view θₐ and a maximum angle of view θₘₐₓ of the lens unit 101 preferably falls within a range from 0.15 to 0.35. In the embodiment, the lens unit 101 having the optical characteristics is also referred to as a different-angle-of-view lens unit.

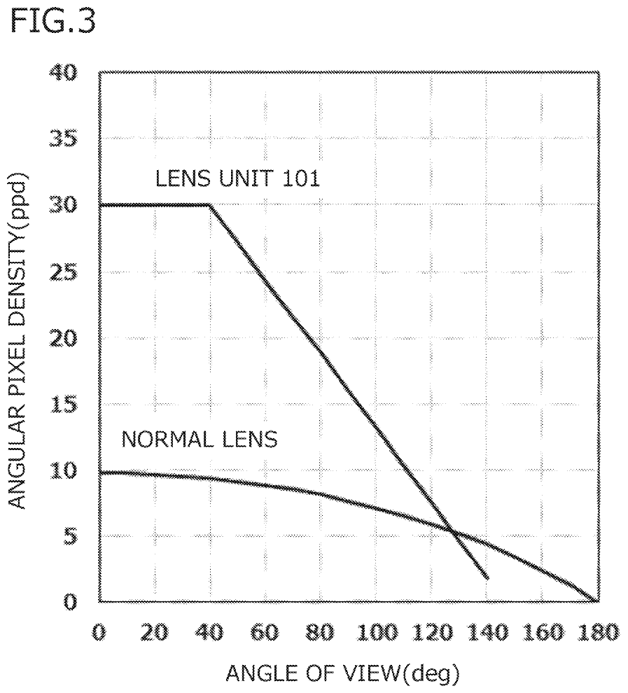

FIG. 3 is a graph illustrating an example of angular pixel density, which represents resolution, in a case where the lens unit 101 according to the embodiment is incorporated into the head-mounted display 100 and in a case where a fisheye lens, which is a normal lens, is incorporated into the head-mounted display 100. Here, a head-mounted display is assumed in which the image sensor 103 has a pixel pitch of 4 μm, the lens has an F-number of 2.0, the imaging angle of view is 120 degrees, and video is displayed at 90 fps. The lens unit 101 and the normal lens have designs that achieve substantially the same level of angular pixel density. In this case, while the focal length of the normal lens is 1.4, the focal length of the lens unit 101 can be increased up to 5.7. With an increase in focal length, angular pixel density is expected to increase from approximately 10 ppd to approximately 30 ppd.

As described above, in the head-mounted display 100 shown in FIGS. 1A and 1B, an imaging unit includes at least the lens unit 101 and the image sensor 103. The head-mounted display 100 includes a plurality of imaging units. In one embodiment, the high-resolution region of the lens unit 101 corresponds to an effective visual field region of the eyeball 109. The low-resolution region of the lens unit 101 corresponds to a peripheral visual field region of the eyeball 109. In the head-mounted display 100, the high-resolution region of the lens unit 101 is allocated to an effective visual field, which is a range within a human visual field that can be viewed by eye movement. Also, in the head-mounted display 100, the low-resolution region of the lens unit 101 is allocated to a peripheral visual field, which is a range in which shapes and colors of objects cannot be clearly distinguished.

According to the above-described allocation of resolution regions, the low-resolution region of the lens unit 101 is allocated to a visual field region that is less distinguishable than other regions among a plurality of visual field regions of the user, so that the user becomes less likely to distinguish differences in resolution among the plurality of visual field regions. In this way, in the embodiment, even when the lens unit 101 having a plurality of resolution regions including a high-resolution region and a low-resolution region is used in an imaging unit, a sense of discomfort a user feels with respect to video can be easily suppressed.

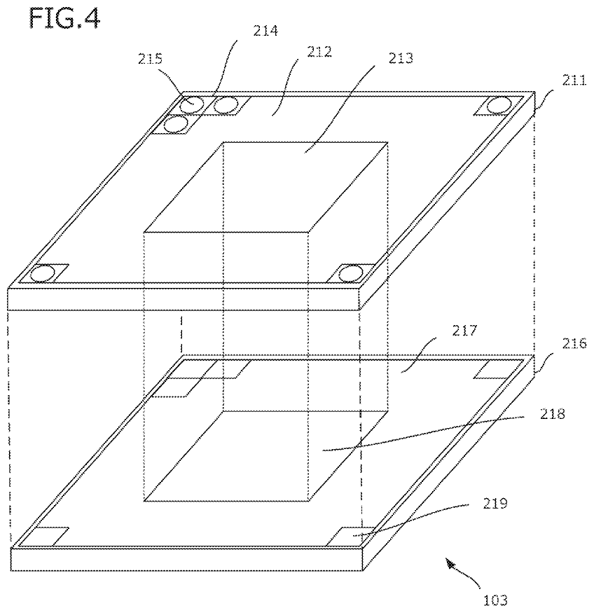

FIG. 4 is a view of an exemplary configuration of the image sensor 103 according to the embodiment. As shown in FIG. 4, the image sensor 103 includes a sensor substrate 211 which receives incident light from the lens unit 101 and a pixel circuit substrate 216. The sensor substrate 211 has a plurality of pixels 214 arranged in a matrix in a plan view of the sensor substrate 211. Each pixel 214 includes an avalanche diode 215 that converts light into an electrical signal. The avalanche diode 215 detects charges derived from light and generates an avalanche current by causing avalanche multiplication. The pixel circuit substrate 216 detects the avalanche current by a charge processing unit 219 and outputs a signal of the pixel 214. In one embodiment, the charge processing units 219 of the pixel circuit substrate 216 are provided to respectively correspond to the pixels 214 of the sensor substrate 211. The charge processing units 219 are arranged in a matrix on the pixel circuit substrate 216.

The plurality of pixels 214 of the sensor substrate 211 are divided into a first pixel region 212 and a second pixel region 213. The charge processing units 219 of the pixel circuit substrate 216 are also divided into a first pixel circuit region 217 and a second pixel circuit region 218 which correspond to the first pixel region 212 and the second pixel region 213, respectively. The pixels 214 from the first pixel region 212 are connected to the charge processing units 219 of the first pixel circuit region 217, and the pixels 214 from the second pixel region 213 are connected to the charge processing units 219 of the second pixel circuit region 218. In one embodiment, the first pixel region 212 includes at least a low-resolution region, and the second pixel region 213 includes at least a high-resolution region. The first pixel region 212 is positioned outside of the second pixel region 213. In the embodiment, the first pixel region 212 may encompass the second pixel region 213 or may be a region excluding the second pixel region 213.

In the example of FIG. 4, the pixel region of the sensor substrate 211 is divided into two pixel regions, but the pixel region is not limited thereto and may be divided into two or more pixel regions. Similarly, the pixel circuit region of the pixel circuit substrate 216 is divided into two pixel circuit regions, but the pixel circuit region is not limited thereto and may be divided into two or more pixel circuit regions. For example, as an intermediate pixel region between the first pixel region 212 and the second pixel region 213, a third pixel region that is smaller than the first pixel region 212 and larger than the second pixel region 213 may be provided. Similarly, as for the pixel circuit regions, an intermediate pixel circuit region may be provided as a third pixel circuit region between the first pixel circuit region 217 and the second pixel circuit region 218.

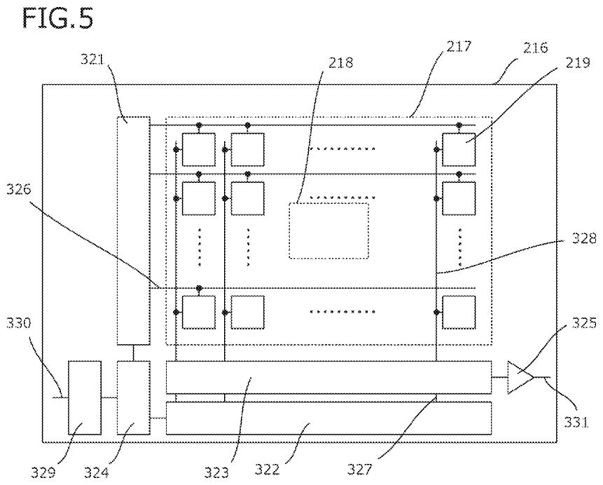

FIG. 5 is a diagram of an exemplary configuration of the pixel circuit substrate 216 according to the embodiment. As shown in FIG. 5, the pixel circuit substrate 216 includes a plurality of charge processing units 219 that detect an avalanche current of the avalanche diode 215 that constitutes the pixel 214 and output a signal. The charge processing units 219 are arranged in a matrix on the pixel circuit substrate 216. The pixel circuit substrate 216 also has at least a vertical scanning circuit unit 321, a horizontal scanning circuit unit 322, a column circuit 323, a control pulse generation unit 324, and an output circuit 325.

The vertical scanning circuit unit 321 receives control pulses supplied from the control pulse generation unit 324 and supplies control pulses to the charge processing units 219 via vertical control lines 326. The vertical control lines 326 include at least a reset line that supplies control pulses for resetting charge processing units 219 and a selection line that supplies control pulses for selecting charge processing units 219.

The vertical control lines 326 may further include an exposure control line that controls an exposure time of the avalanche diode 215. Logic circuits such as a shift register and an address decoder are used for the vertical scanning circuit unit 321. A signal line 328 supplies, to a succeeding column circuit 323, a signal output from the charge processing unit 219 selected by the vertical scanning circuit unit 321 (the signal also being referred to as a signal of the pixel 214).

The signal of the pixel 214 is input to the column circuit 323 via the signal line 328, and the column circuit 323 performs prescribed processing on the input signal. Examples of the processing include noise removal and amplification of the input signal, and conversion of the input signal into a form suitable for output to the outside of the image sensor 103. For example, a parallel-to-serial conversion circuit is used for the column circuit 323.

The horizontal scanning circuit unit 322 supplies, to the column circuit 323, control pulses for sequentially outputting signals processed by the column circuit 323 to the output circuit 325. The output circuit 325 includes a buffer amplifier, a differential amplifier, and the like, and outputs, as pixel signals 331, signals output from the column circuit 323 to the outside of the image sensor 103.

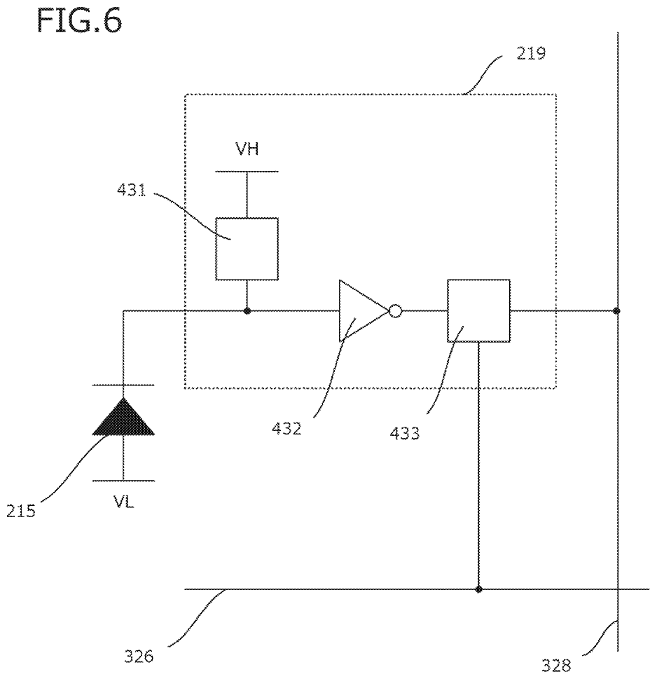

FIG. 6 is a diagram of an exemplary configuration of the charge processing unit 219. As shown in FIG. 6, the charge processing unit 219 includes a quench element 431, a waveform shaping unit 432, and a counter circuit 433. The quench element 431 is connected to a power supply voltage that supplies a voltage VH higher than a voltage VL which will be described later, and is also connected to the avalanche diode 215 of the sensor substrate 211. The voltage VL lower than the voltage VH is supplied to the anode of the avalanche diode 215. The cathode of the avalanche diode 215 is connected to the quench element 431 and the waveform shaping unit 432. A reverse bias voltage is supplied to the avalanche diode 215. When light is incident on the avalanche diode 215 and charges derived from the incident light are generated in the avalanche diode 215, the charges cause avalanche multiplication, resulting in generation of an avalanche current.

Operation modes of the avalanche diode 215 when a reverse-bias voltage is supplied to the avalanche diode 215 include a Geiger mode and a linear mode. In the Geiger mode, the avalanche diode 215 is operated with a potential difference between the anode and the cathode that is greater than a breakdown voltage. In the linear mode, the avalanche diode 215 is operated with a potential difference between the anode and the cathode that is near the breakdown voltage or lower than the breakdown voltage.

The avalanche diode 215 operated in the Geiger mode is referred to as an SPAD (Single Photon Avalanche Diode). In this case, for example, the voltage VL is −30 V and the voltage VH is 1 V. The avalanche diode 215 may be operated either in the linear mode or in the Geiger mode. In one embodiment, the avalanche diode 215 is an SPAD, since a potential difference is larger than that in the linear mode and the avalanche multiplication effect becomes more pronounced in the case of an SPAD.

The quench element 431 functions as a load circuit (quench circuit) during signal amplification by avalanche multiplication. The quench element 431 suppresses avalanche multiplication by limiting a voltage supplied to the avalanche diode 215 (quench operation). The quench element 431 restores the voltage supplied to the avalanche diode 215 to the voltage VH by allowing a current corresponding to a voltage drop caused by the quench operation to flow (recharge operation). The quench element 431 may be, for example, a resistive element.

The quench element 431 may include a switch element that opens and closes a voltage supply path to the avalanche diode 215. For example, the switch element of the quench element 431 may include a transistor, and an exposure time can be adjusted by an exposure control line (which is not shown) of the vertical control lines 326. During a period in which the switch element is closed, a voltage is supplied to the avalanche diode 215, and detection of charges derived from incident light is performed.

The waveform shaping unit 432 shapes a potential change at the cathode of the avalanche diode 215 obtained during charge detection and outputs a pulse signal. As the waveform shaping unit 432, for example, an inverter circuit may be used. FIG. 6 illustrates an example in which a single inverter is used as the waveform shaping unit 432, but a circuit including a plurality of inverters connected in series may be used as the waveform shaping unit 432, and other circuits having a waveform shaping effect may also be used.

The counter circuit 433 includes at least a counter that counts pulse signals output from the waveform shaping unit 432 and a selection circuit. The pulse signals output from the waveform shaping unit 432 are counted by the counter of the counter circuit 433. When the counter is an N-bit counter (N: a positive integer), the counter circuit 433 is capable of counting the pulse signals output from the waveform shaping unit 432 up to approximately 2^{N} pulses. The signals counted by the counter circuit 433 are digital signals and held as signals of the pixels 214.

When control pulses are supplied from the vertical scanning circuit unit 321 via a reset line included in the vertical control lines 326, the counter of the counter circuit 433 resets the signals of the pixels 214 being held. The counter circuit 433 may include a switch circuit that opens and closes a signal path for the pulse signals output from the waveform shaping unit 432. The switch circuit of the counter circuit 433 opens and closes in response to a signal from an exposure control line (which is not shown) of the vertical control lines 326, and, for example, in one embodiment, performs counting operation only during a period in which the switch circuit is closed.

The selection circuit of the counter circuit 433 switches between an electrical connection and a non-connection between the counter of the counter circuit 433 and the signal line 328, in response to control pulses supplied from the vertical scanning circuit unit 321 via a selection line included in the vertical control lines 326. The selection circuit of the counter circuit 433 may include a transistor, a buffer circuit, or the like.

The circuit configuration of the avalanche diode 215 and the circuit configuration of the image sensor 103 described above are disclosed, for example, in Japanese Patent Laid-Open No. 2024-121777. The circuit configurations of the avalanche diode 215 and the image sensor 103 are not limited to those described above.

The pixel circuit substrate 216 according to the embodiment will be further described with reference to FIG. 5. For example, unlike the circuit configuration disclosed in Japanese Patent Laid-Open No. 2024-121777, the circuit configuration of the pixel circuit substrate 216 according to the embodiment includes a pixel region setting unit 329. The pixel region setting unit 329 is an allocation unit that controls the control pulse generation unit 324 to allocate a region of the charge processing units 219 corresponding to the pixel signals 331. More specifically, charge processing units 219 in a row direction are selected by the vertical scanning circuit unit 321, and charge processing units 219 in a column direction are selected by the horizontal scanning circuit unit 322. Signals from a region selected by the pixel region setting unit 329 are output as pixel signals 331 via the output circuit 325. The pixel region setting unit 329 refers to a region control signal 330 input from outside and selects or switches a region of the pixels 214. In other words, in response to the region control signal 330, the pixel region setting unit 329 of the pixel circuit substrate 216 of the image sensor 103 changes a region of the pixels 214 from which the pixel signals 331 are generated. Accordingly, the pixel region setting unit 329 allocates a plurality of pixels of the sensor substrate into a first pixel region including at least a low-resolution region and a second pixel region including at least a high-resolution region.

For example, the pixel circuit substrate 216 can alternately select a signal of the first pixel circuit region 217 and a signal of the second pixel circuit region 218, and selectively output the selected signals sequentially as pixel signals 331. The counter circuit 433 in FIG. 6 holds a counter value unless a reset line of the vertical control lines 326 transitions to an effective state. Therefore, the charge processing unit 219 can read out the counter value, which is a signal of the pixel 214, multiple times. This differs from a pixel circuit configuration of a CMOS sensor, in which a pixel signal value is reset when the pixel signal is read out. Because of this feature, for example, a pixel signal 331 from the first pixel region 212 corresponding to the first pixel circuit region 217 and a pixel signal 331 from the second pixel region 213 corresponding to the second pixel circuit region 218 can be acquired at different timings from the start of exposure.

In the embodiment, the angle-of-view range of the lens unit 101 is assumed to be, for example, 120 degrees. Since the lens unit 101 is a wide-angle lens, a reduction in peripheral light amount occurs, and a peripheral visual field region becomes darker than an effective visual field region. In the configuration of the embodiment, signals from the first pixel circuit region 217 corresponding to the peripheral visual field region and signals from the second pixel circuit region 218 corresponding to the effective visual field region can be extracted at different timings from the start of exposure.

For example, photon counting in the effective visual field region and the peripheral visual field region is started from the start of exposure, and pixel signals from the effective visual field region are extracted after t₁ seconds. Thereafter, photon counting in each region is resumed, and pixel signals from the peripheral visual field region are extracted after t₂ seconds. In the embodiment, the difference between t₁ seconds and t₂ seconds corresponds to a difference in exposure time, making it possible to suppress a difference in brightness between the effective visual field region and the peripheral visual field region. Accordingly, in the head-mounted display 100 according to the embodiment, processing related to correction of a reduction in peripheral light amount can be reduced, and improvement in processing latency executed by the head-mounted display 100 can also be expected.

According to the head-mounted display 100 of the embodiment, a photon detection limit can be lowered by the avalanche diode 215, and resolution in an effective visual field region can be increased by the lens unit 101. Accordingly, it is possible to provide a head-mounted display that secures required resolution even under reduced ambient illuminance, thereby enabling use cases of conventional head-mounted displays to be expanded.

### Example 1

Next, a configuration of a head-mounted display according to Example 1 of the first embodiment will be described with reference to the drawings. In the following description, components that are the same as those of the first embodiment are denoted by the same reference numerals, and detailed description thereof will not be provided.

In the lens unit 101 of the present example, an angle of view θₐ corresponding to a high-resolution region is 60 degrees, a maximum angle of view θₘₐₓ is 180 degrees, and a focal length f is 5 mm, and the high-resolution region is set in an effective visual field region of the eyeball 109. Since an angle of view of the head-mounted display 100 is assumed to be 120 degrees, an angle of view of the lens unit 101 is an angle of view that encompasses the angle of view assumed for the head-mounted display 100. A ratio θₐ/θₘₐₓ between the angle of view θₐ and the maximum angle of view θₘₐₓ of the lens unit 101 is 0.34, and a characteristic f sin(θₘₐₓ/2)/y(θₘₐₓ/2) of the lens unit 101 is 1.16.

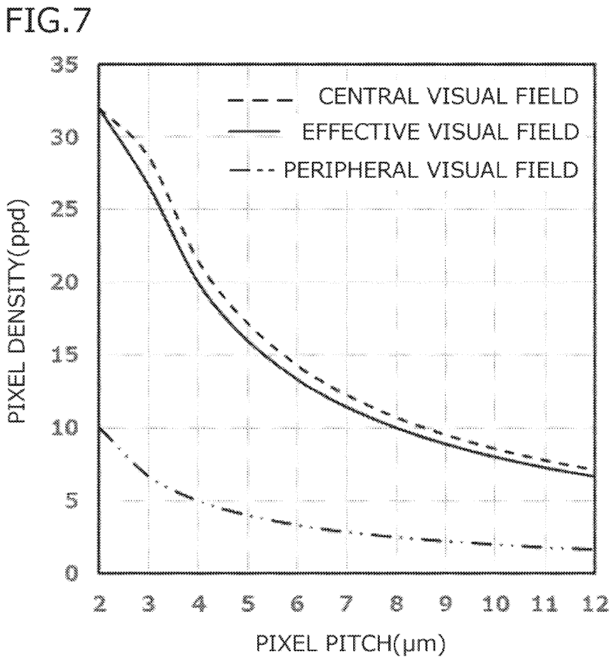

FIG. 7 illustrates angular pixel density of the head-mounted display 100 with respect to pixel pitch of the image sensor 103 when the above-described lens unit 101 is used. More specifically, estimated values of angular pixel density are plotted for regions of a central visual field, an effective visual field, and a peripheral visual field. In consideration of use of the head-mounted display 100 under low ambient illuminance, the image sensor 103 is assumed to be a sensor using SPADs as pixels in order to expand use cases of the head-mounted display 100. Further, the display panel 105 is assumed to be a so-called 4K-by-4K panel using OLEDs (Organic Light Emitting Diodes) or LEDs (Light Emitting Diodes) as light-emitting elements for pixels.

In FIG. 7, by setting the high-resolution region of the lens unit 101 in the effective visual field region, characteristics of the effective visual field and the central visual field exhibit substantially the same characteristics with respect to pixel pitch of the SPAD. As described above, assuming that an angular pixel density of 20 ppd is a resolution level that does not impair workability of a user of the head-mounted display 100, in one embodiment, the pixel pitch of the image sensor 103 is 4.5 μm or less in the effective visual field and the central visual field. For example, in the graph shown in FIG. 14, when ambient illuminance is assumed to have a lower limit of 10 mlx, and an SPAD is assumed as the image sensor 103, the pixel pitch is limited to 4 μm or more due to a detection limit. That is, the pixel pitch of a plurality of pixels of the image sensor 103 is at least 4 μm and not more than 4.5 μm.

In order to realize the above-described characteristics, in one embodiment, the image circle of the lens, which reflects the image height characteristics of the lens unit 101, is approximately Φ8 mm or more, and the sensor size is ½-type or larger. Considering that the lens unit 101 is incorporated into the head-mounted display 100 and that an imaging unit including the lens unit 101 is arranged within the interpupillary distance of left and right eyes, it is to set the image circle at Φ16 mm and the upper limit of the sensor size at a 1-type sensor.

According to the head-mounted display 100 of the embodiment, since it is possible to provide a head-mounted display which secures required resolution even under reduced ambient illuminance, thereby enabling use cases of conventional head-mounted displays to be expanded.

### Example 2

Next, a configuration of a head-mounted display according to Example 2 of the first embodiment will be described with reference to the drawings. In the following description, components that are the same as those of the first embodiment are denoted by the same reference numerals, and detailed description thereof will not be provided.

In the lens unit 101 according to this example, an angle of view θₐ corresponding to a high-resolution region is 20 degrees, a maximum angle of view θₘₐₓ is 120 degrees, and a focal length f is 10 mm, and the high-resolution region is set in a region of a central visual field of the eyeball 109. Since the angle of view of the head-mounted display 100 is assumed to be 120 degrees, the angle of view of the lens unit 101 is substantially equal to the angle of view assumed for the head-mounted display 100. A ratio θₐ/θₘₐₓ between the angle of view θₐ and the maximum angle of view θₘₐₓ of the lens unit 101 is 0.16, and a characteristic f sin(θₘₐₓ/2)/y(θₘₐₓ/2) of the lens unit 101 is 1.52.

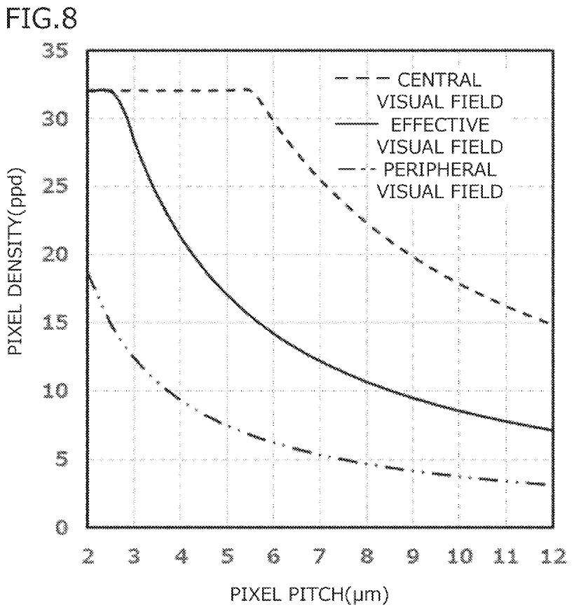

FIG. 8 illustrates the angular pixel density of the head-mounted display 100 with respect to the pixel pitch of the image sensor 103 when the above-described lens unit 101 is used. More specifically, estimated values of the angular pixel density are plotted for regions of a central visual field, an effective visual field, and a peripheral visual field. Considering that the head-mounted display 100 is to be used under low ambient illuminance and in order to expand use cases of the head-mounted display 100, it is assumed that the image sensor 103 is a sensor having SPADs as pixels. The display panel 105 is assumed to be a so-called 4K-by-4K panel having OLED or LED light-emitting elements as pixels.

In FIG. 8, the angular pixel density of the head-mounted display 100 satisfies a relationship represented by “(angular pixel density of the central visual field)>(angular pixel density of the effective visual field)>(angular pixel density of the peripheral visual field).” Upper limits for the angular pixel density of the central visual field and the effective visual field are 32 ppd, which is a display limit for the 4K-by-4K panel serving as the display panel 105. As described above, assuming that an angular pixel density of 20 ppd is a resolution level that does not impair workability of the user of the head-mounted display 100, in one embodiment, the image sensor 103 has a pixel pitch of 9 μm or less in the central visual field. In the effective visual field, the pixel pitch of the image sensor 103 is 4.2 μm or less.

As described above, when SPADs are assumed as pixels of the image sensor 103, a lower limit for the pixel pitch is 4 μm due to a detection limit. That is, in one embodiment, in the central visual field, the pixel pitch of a plurality of pixels of the image sensor 103 is at least 4 μm and not more than 9 μm. In the effective visual field, the pixel pitch of the plurality of pixels of the image sensor 103 is at least 4 μm and not more than 4.2 μm.

In order to realize the above-described characteristics, in one embodiment, the image circle of the lens in a region of the effective visual field, which reflects the image height characteristics of the lens unit 101, is approximately Φ12 mm or more, and the sensor size is ⅔-type or larger. As shown in FIG. 8, in a region of the central visual field, the angular pixel density is constant up to a pixel pitch of 5.5 μm in a 4K-by-4K panel due to display characteristics of the display panel 105.

Therefore, in consideration of the lower limit for the pixel pitch of SPADs, which is 4 μm, in one embodiment, the image circle is approximately Φ9 mm or more, and the sensor size is 1/1.8-type or larger. Considering that the lens unit 101 is incorporated into the head-mounted display 100, an imaging unit including the lens unit 101 is arranged within the interpupillary distance of left and right eyes. Accordingly, the imaging unit including the lens unit 101 has an upper limit of Φ16 mm for the image circle and an upper limit of a 1-type sensor for the sensor size.

From characteristics of sensor sizes in Examples 1 and 2, in one embodiment, a plurality of pixels of the substrate 104 fall within a sensor size from ½-type to 1-type. The first pixel region 212 and the second pixel region 213 are arranged to be inscribed in, circumscribed about, or disposed inside of the image circle of the lens unit 101, which is in the range from Φ8 to Φ16.

The head-mounted display 100 provided according to the embodiment enables required resolution to be secured even under reduced ambient illuminance, thereby enabling use cases of conventional head-mounted displays to be expanded.

### Second Embodiment

Next, a configuration of a head-mounted display according to a second embodiment will be described with reference to the drawings. In the following description, components that are the same as those of the first embodiment are denoted by the same reference numerals, and detailed description thereof will not be provided.

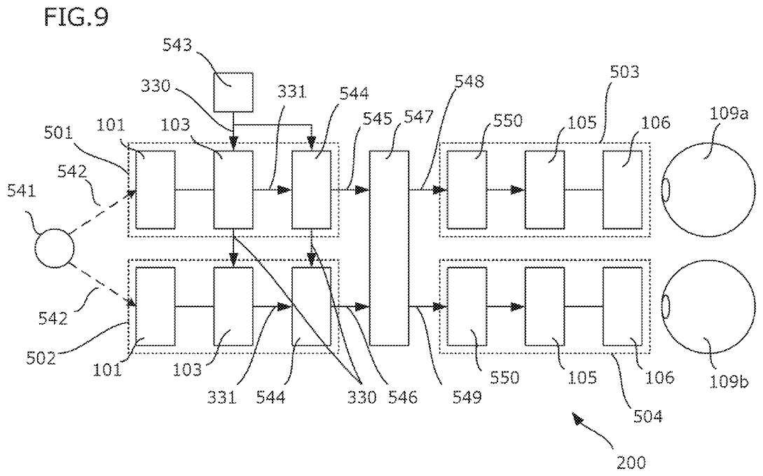

FIG. 9 is a diagram of an exemplary system configuration of a head-mounted display 200 according to the embodiment. The head-mounted display 200 includes a first imaging unit 501 and a second imaging unit 502 that detect photons 542 reflected from an object 541. The first imaging unit 501 outputs a first video signal 545. The second imaging unit 502 outputs a second video signal 546.

The first imaging unit 501 and the second imaging unit 502 each include the lens unit 101 and the image sensor 103 that constitute the imaging unit of the first embodiment. The image sensor 103 includes a sensor substrate 211 and a pixel circuit substrate 216. The pixel circuit substrate 216 includes a pixel region setting unit 329. The pixel region setting unit 329 allocates a plurality of pixels 214 of the sensor substrate 211 to a first pixel region 212 including at least a low-resolution region and to a second pixel region 213 including at least a high-resolution region.

The first imaging unit 501 and the second imaging unit 502 each include a video signal conversion unit 544 that converts data of pixel signals 331 output from the pixel circuit substrate 216 of the image sensor 103 into a video signal. The video signal conversion unit 544 is a first conversion unit that converts pixel signals into first video data of pixel signals from the first pixel region 212 and second video data of pixel signals from the second pixel region 213. The first imaging unit 501 and the second imaging unit 502 each include a video signal conversion unit 544. The video signal conversion unit 544 of the first imaging unit 501 outputs, for the user's right eye, a first video signal 545 including the first video data and the second video data. The video signal conversion unit 544 of the second imaging unit 502 outputs, for the user's left eye, a second video signal 546 including the first video data and the second video data.

The head-mounted display 200 includes a control unit 543. The control unit 543 outputs a region control signal 330. In response to the region control signal 330, the image sensor 103 selects or switches a region of pixels 214 from which pixel signals 331 are generated. The video signal conversion unit 544 refers to the region control signal 330, acquires information on an arrangement of the pixels 214 in a designated region (for example, the number of pixels in a row direction and the number of pixels in a column direction), and generates a video signal from the pixel signals 331. In one embodiment, the video signal is a signal in compliance with a prescribed interface standard. Examples of the interface standard that can be applied include a USB standard, an HDMI® standard, or an MIPI standard. However, applicable interface standards are not limited to the above.

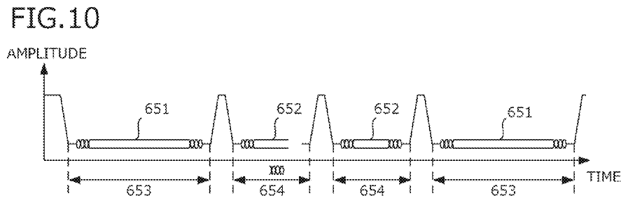

FIG. 10 is a chart illustrating an operation example of the video signal conversion unit 544. The head-mounted display 200 switches, by the control unit 543, between a time period during which pixel signals 331 corresponding to the first pixel region 212 are output and a time period during which pixel signals 331 corresponding to the second pixel region 213 are output. The first pixel region 212 is, for example, a peripheral visual field region corresponding to a low-resolution region of the lens unit 101. The second pixel region 213 is an effective visual field region corresponding to a high-resolution region of the lens unit 101.

The video signal conversion unit 544 refers to information on an arrangement of pixels 214 included in the first pixel region 212 and to the pixel signals 331 output from the image sensor 103, and converts the pixel signals into a first video signal including first video data 651 of pixel signals 331 from the first pixel region 212. The video signal conversion unit 544 refers to information on an arrangement of pixels 214 included in the second pixel region 213 and to the pixel signals 331 output from the image sensor 103 and converts pixel signals into a second video signal including second video data 652 of the pixel signals 331 from the second pixel region 213.

As shown in FIG. 4, since the first pixel region 212 is larger than the second pixel region 213, the number of pixels 214 included in the first pixel region 212 is larger than the number of pixels 214 included in the second pixel region 213. Therefore, as illustrated in FIG. 10, the first video data 651 has a larger data size than the second video data 652, and a first video data transmission period 653 is longer than a second video data transmission period 654.

The first video data 651 includes video data of a peripheral visual field, which is a range in which a user cannot clearly distinguish shapes and colors of objects, and video data of an effective visual field, which is a range that can be viewed by eye movement of the user. The second video data 652 includes video data of the effective visual field, which is a range that can be viewed by eye movement of the user.

By utilizing the low visibility of a user to the peripheral visual field in the head-mounted display 200, the head-mounted display 200 can be driven in the following manner. For example, after the first video data 651 is updated and an image including the peripheral visual field is presented to the user, in one embodiment, only video of an effective visual field near a center of the visual field, which is the second video data 652, is updated. Since the user has low visibility to an image of the peripheral visual field corresponding to the difference between the first video data 651 and the second video data 652, a sense of discomfort a user feels with respect to the video image is unlikely to be increased when compared to a case in which the entire video presented to the user by the first video data 651 is updated.

In the example in FIG. 10, after the first video data 651 is transmitted, the second video data 652 is transmitted twice consecutively. This corresponds to updating video including the peripheral visual field followed by updating only video of the effective visual field twice consecutively, in the head-mounted display 200. In other words, in the head-mounted display 200, the video signal conversion unit 544 outputs the first video data 651 and the second video data 652 at mutually different frame rates.

According to the head-mounted display 200 of the embodiment, in one embodiment, the time length of the first video data transmission period 653 for transmitting video including the peripheral visual field is different from the time length of the second video data transmission period 654 for transmitting only video of the effective visual field. Therefore, compared with a case in which video including the peripheral visual field is entirely updated, updating the peripheral visual field and the effective visual field at different frame rates can reduce a total time required for data transfer. Accordingly, in the head-mounted display 200, power consumption required for data transfer can be reduced as compared with a conventional head-mounted display, thereby enabling power consumption of the head-mounted display to be reduced.

The head-mounted display 200 will be further described with reference to FIG. 9. The imaging unit of the head-mounted display 200 includes a first imaging unit 501 that outputs a first video signal 545, which is a video signal in compliance with an interface standard, for the user's right eye. The imaging unit of the head-mounted display 200 further includes a second imaging unit 502 that outputs a second video signal 546, which is a video signal in compliance with the interface standard, for the user's left eye. In FIG. 9, the first imaging unit 501 mainly captures video to be displayed on the right eye 109a. The second imaging unit 502 mainly captures video to be displayed on the left eye 109b. FIG. 9 illustrates a configuration in which the head-mounted display 200 includes two imaging units, but the head-mounted display 200 may include three or more imaging units.

The head-mounted display 200 further includes a processing unit 547 that converts the first video signal 545 and the second video signal 546 into a first parallax video signal 548 for the user's right eye 109a and a second parallax video signal 549 for the user's left eye 109b. The processing unit 547 is a second conversion unit that converts the first video signal output from the first imaging unit into a first parallax video signal for the user's right eye, and converts the second video signal output from the second imaging unit into a second parallax video signal for the user's left eye.

In one embodiment, the first parallax video signal 548 and the second parallax video signal 549 are video signals in compliance with an interface standard. The first parallax video signal 548 and the second parallax video signal 549 represent parallax video corresponding to the interpupillary distance between the user's right eye 109a and left eye 109b. Therefore, the first imaging unit 501 and the second imaging unit 502 are arranged with a spacing substantially equal to the interpupillary distance.

The processing unit 547 may include an image processing unit. The image processing unit may perform, for example, correction processing for performance variations among pixels 214 of the sensor substrate 211 of the image sensor 103, or correction processing for defects of the pixels 214. The image processing unit may also perform distortion correction processing of the lens unit 101 and correction processing for peripheral light falloff. The image processing unit may also perform adjustment processing for alignment errors between the lens unit 101 and the image sensor 103. The image processing unit may also perform adjustment processing for posture misalignment between the first imaging unit 501 and the second imaging unit 502. The image processing unit may also perform averaging processing for improving an S/N ratio. The averaging processing includes frame addition processing and averaging or smoothing processing with adjacent pixels.

The various types of processing executed by the image processing unit described above may be executed for the entire video signal, or may be executed for a part of the video signal. For example, the image processing unit may execute different kinds of processing or execute processing under different conditions for a portion of video corresponding to a peripheral visual field and for a portion of video corresponding to an effective visual field. The processing executed by the processing unit 547 is not limited to the processing described above, and may include processing generally performed for a head-mounted display.

The head-mounted display 200 includes a first display unit 503 that projects, to the right eye 109a, video using the first parallax video signal 548, and a second display unit 504 that projects, to the left eye 109b, video using the second parallax video signal 549. Similarly to the imaging units, in one embodiment, the first display unit 503 and the second display unit 504 are arranged with a spacing substantially equal to the interpupillary distance. In the following description, the first display unit 503 and the second display unit 504 may be collectively referred to as a display unit.

The first display unit 503 includes a display panel 105 that projects, via a display optical unit 106, video using the first parallax video signal 548 to the right eye 109a and a display driver 550 that drives the display panel 105. The second display unit 504 includes a display panel 105 that projects, via a display optical unit 106, video using the second parallax video signal 549 to the left eye 109b, and a display driver 550 that drives the display panel 105.

The display driver 550 may update all the pixels of the display panel 105 at a time, or may partially update the pixels. For example, in accordance with the transmission sequence illustrated in FIG. 10, pixels corresponding to a high-resolution region (effective visual field) and pixels corresponding to a low-resolution region (peripheral visual field) may be updated at different frame rates.

According to the head-mounted display 200 of the embodiment, by utilizing low visibility of the user to the peripheral visual field, pixel update rates can be adjusted for each region without increasing a sense of discomfort a user feels with respect to video. According to the head-mounted display 200, the update rate of pixels near a peripheral region of the visual field can be made lower than the update rate of pixels near a central region of the visual field. Since the head-mounted display 200 can adjust video update rates for the regions divided as described above, power consumption for driving the display panel 105 can be suppressed as compared with a conventional head-mounted display.

### Third Embodiment

Next, a configuration of a head-mounted display according to a third embodiment will be described with reference to the drawings. In the following description, components that are the same as those of the first and second embodiments are denoted by the same reference numerals, and detailed description thereof will not be provided.

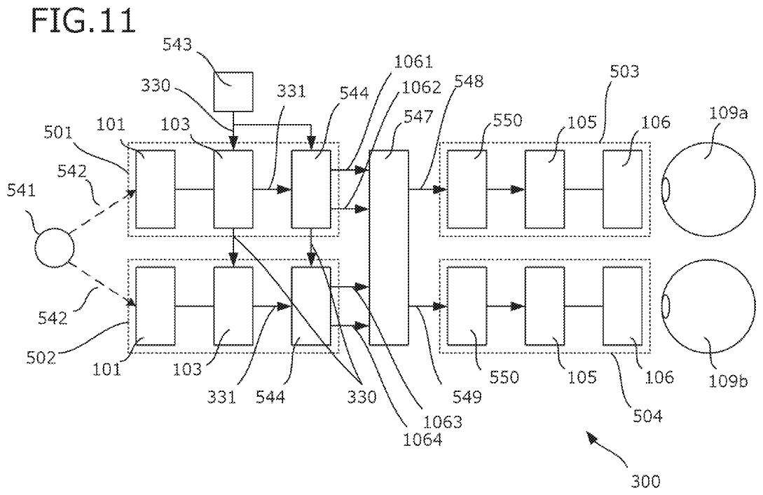

FIG. 11 is a diagram illustrating an exemplary system configuration of a head-mounted display 300 according to the embodiment. Compared with the head-mounted display 200 according to the second embodiment, the head-mounted display 300 differs in the number of signal paths from imaging units to the processing unit 547 and includes a plurality of signal paths. The first imaging unit 501 of the head-mounted display 300 outputs a first effective visual field video signal 1061 and a first peripheral visual field video signal 1062 in parallel. The second imaging unit 502 of the head-mounted display 300 outputs a second effective visual field video signal 1063 and a second peripheral visual field video signal 1064 in parallel. The first imaging unit 501 outputs the first effective visual field video signal 1061 and the first peripheral visual field video signal 1062 at mutually different frame rates. The second imaging unit 502 outputs the second effective visual field video signal 1063 and the second peripheral visual field video signal 1064 at mutually different frame rates.

The first effective visual field video signal 1061 and the second effective visual field video signal 1063 are mainly related to the second pixel region 213 of the image sensor 103 and are video signals for a central visual field region or an effective visual field region. The first peripheral visual field video signal 1062 and the second peripheral visual field video signal 1064 are mainly related to the first pixel region 212 of the image sensor 103 and are video signals for a peripheral visual field region.

In the second embodiment, as illustrated in FIG. 10, first video data 651 corresponding to a peripheral visual field video signal and second video data 652 corresponding to an effective visual field video signal are transmitted in series. In contrast, in the embodiment, since paths for these pieces of data are provided to be in parallel, data transmission can be performed in a shorter time than in the head-mounted display 200 according to the second embodiment, and improvement in latency of the head-mounted display can be expected. In this way, it can be expected that processing for securing required resolution to be executed more suitably even under reduced ambient illuminance in the head-mounted display 300.

The head-mounted display 300 according to the embodiment eliminates the need for processing for extracting image signals of respective regions from a video signal in signal processing performed by the processing unit 547 or image processing performed by an image processing unit of the processing unit 547. Accordingly, the head-mounted display 300 further reduces a processing load compared with the first embodiment and the second embodiment, and enables improvement in latency of the head-mounted display. In this way, it can be expected that processing for securing required resolution to be executed more suitably even under reduced ambient illuminance in the head-mounted display 300.

### Fourth Embodiment

Next, a configuration of a head-mounted display according to a fourth embodiment will be described with reference to the drawings. In the following description, components that are the same as those of the first to third embodiments are denoted by the same reference numerals, and detailed description thereof will not be provided.

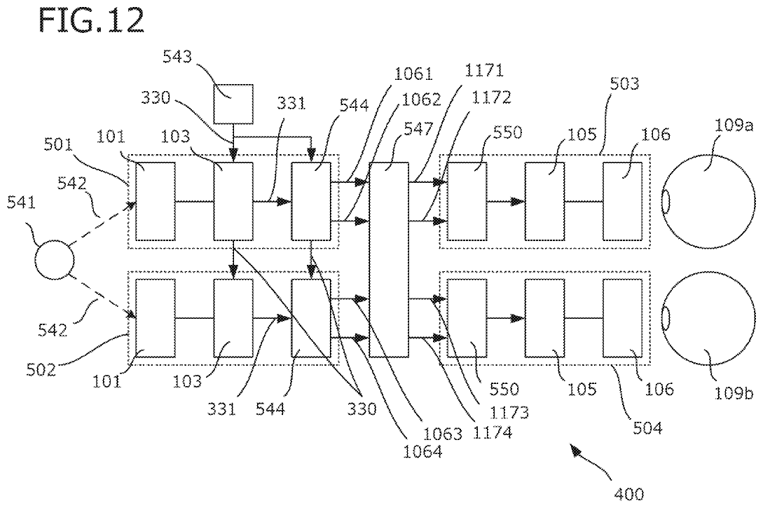

FIG. 12 is a diagram illustrating an exemplary system configuration of a head-mounted display 400 according to the embodiment. Compared with the head-mounted display 300 according to the third embodiment, the head-mounted display 400 differs in the number of signal paths from the processing unit 547 to the display driver 550 and has a plurality of signal paths. The processing unit 547 of the head-mounted display 400 outputs a first effective visual field parallax video signal 1171 and a first peripheral visual field parallax video signal 1172 in parallel to the display driver 550 of a first display unit 503. The processing unit 547 of the head-mounted display 400 outputs a second effective visual field parallax video signal 1173 and a second peripheral visual field parallax video signal 1174 in parallel to the display driver 550 of a second display unit 504. Accordingly, the processing unit 547 outputs, in parallel, a parallax video signal corresponding to first video data and a parallax video signal corresponding to second video data among first parallax video signals. The processing unit 547 outputs, in parallel, a parallax video signal corresponding to first video data and a parallax video signal corresponding to second video data among second parallax video signals. The processing unit 547 outputs the first effective visual field parallax video signal 1171 and the first peripheral visual field parallax video signal 1172 at mutually different frame rates. The processing unit 547 outputs the second effective visual field parallax video signal 1173 and the second peripheral visual field parallax video signal 1174 at mutually different frame rates.

The first effective visual field parallax video signal 1171 and the second effective visual field parallax video signal 1173 are mainly signals related to images projected onto an effective visual field and a central visual field of a user. The first peripheral visual field parallax video signal 1172 and the second effective visual field parallax video signal 1173 are mainly signals related to videos projected onto a peripheral visual field of the user. The video signal conversion unit 544 outputs an effective visual field video signal and a peripheral visual field video signal in parallel, but similarly to the first video signal 545 in the head-mounted display 200 according to the second embodiment, these video signals may be output in series.

According to the head-mounted display 400 of the embodiment, parallax video signals input to the respective display drivers 550 are, for example, divided for each visual field region and transmitted in parallel. Accordingly, the head-mounted display 400 enables data transmission to be performed in a shorter time than the head-mounted displays according to the above-described embodiments and improvement in latency can be expected. In this way, it can be expected that processing for securing required resolution can be executed more suitably even under reduced ambient illuminance in the head-mounted display 400.

### Fifth Embodiment

Next, a configuration of a head-mounted display according to a fifth embodiment will be described with reference to the drawings. In the following description, components that are the same as those of the first to fourth embodiments are denoted by the same reference numerals, and detailed description thereof will not be provided. The head-mounted display 500 according to the embodiment corresponds to a modification of the head-mounted display 200 according to the second embodiment.

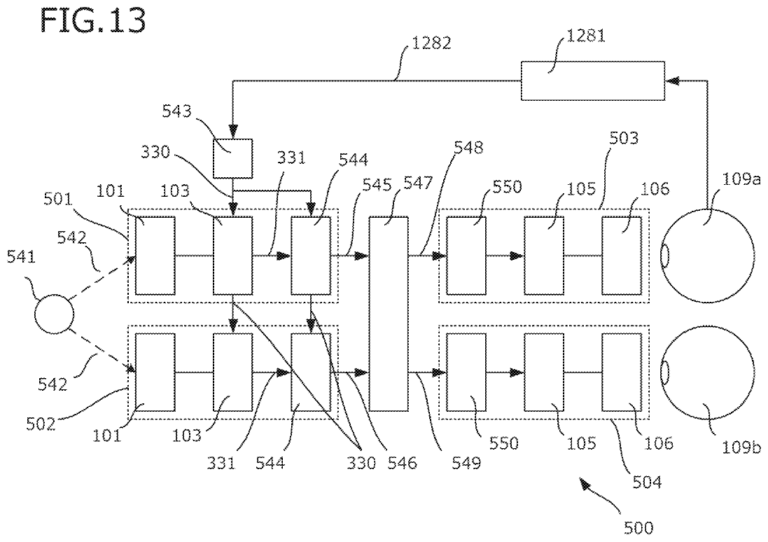

FIG. 13 is a diagram illustrating an exemplary system configuration of the head-mounted display 500 according to the embodiment. The head-mounted display 500 includes a line-of-sight detection unit 1281 that detects lines of sight of a right eye 109a and a left eye 109b of a user. The line-of-sight detection unit 1281 calculates a region at which the user gazes on the basis of the detected lines of sight of the respective eyes, and outputs gaze region coordinates 1282 as a calculation result. The gaze region coordinates 1282 are center coordinates of a second pixel circuit region 218 of a pixel circuit substrate 216 of the image sensor 103. The gaze region coordinates 1282 are center coordinates of a second pixel region 213 of the image sensor 103.

The control unit 543 refers to gaze region coordinates 1282 output from the line-of-sight detection unit 1281, controls the pixel region setting unit 329, and dynamically changes the second pixel circuit region 218 and/or the second pixel region 213 in accordance with changes in detected lines of sight. The control unit 543 then projects, to the right eye 109a and the left eye 109b of a user, peripheral visual field video and an effective visual field or central visual field video centered on the line of sight. In one embodiment, dynamic change of the second pixel circuit region 218 and/or the second pixel region 213 under control of the pixel region setting unit 329 by the control unit 543 is performed inside of a high-resolution region of a lens unit 101.

Accordingly, with the head-mounted display 500 according to the embodiment, an effective visual field or a central visual field is dynamically changed on the basis of a gaze region of the user calculated using detected lines of sight. In this way, it can be expected that high-resolution video can be provided to the user more stably and a sense of discomfort a user feels with respect to video can be further suppressed in the head-mounted display 500.

The embodiments described above merely represent examples of specific implementations for carrying out the technology of the disclosure, and the technical scope of the disclosure should not be interpreted in a limited manner on the basis of these embodiments. That is, the technology of the disclosure can be implemented in various forms without departing from its technical concept or its essential features. The above-described embodiments may be implemented in appropriate combinations.

According to the disclosure, an imaging apparatus and an imaging display apparatus using the imaging apparatus enable required resolution to be secured even under reduced ambient illuminance, thereby enabling use cases of the imaging apparatus and the imaging display apparatus to be expanded.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-064214, filed Apr. 9, 2025, which is hereby incorporated by reference herein in its entirety.

What is claimed is:

1. An apparatus comprising:
a lens unit having a first region corresponding to an angle of view greater than an angle of view θₐ and a second region corresponding to an angle of view equal to or smaller than the angle of view θₐ, wherein a change amount in image height in the second region is larger than a change amount in image height in the first region; and
an imaging unit including a sensor substrate having a plurality of pixels each including an avalanche diode, on which light from the lens unit is incident, and a pixel circuit substrate that outputs pixel signals of the plurality of pixels,
wherein when a maximum angle of view of the lens unit is θₘₐₓ, a focal length is f, and an image height at an angle of view, which is one half of the maximum angle of view θₘₐₓ, is y(θₘₐₓ/2), the following expression (1) is satisfied:
$$1 < \frac{f \times sin \frac{{θ}_{max}}{2}}{y ( \frac{{θ}_{max}}{2} )} . \qquad ( 1 )$$

2. The apparatus according to claim 1, wherein the first region includes a peripheral visual field region, and the second region includes an effective visual field region.

3. The apparatus according to claim 1, wherein the plurality of pixels have a pixel pitch of at least 4 μm and not more than 9 μm.

4. The apparatus according to claim 1, wherein the plurality of pixels have a pixel pitch of at least 4 μm and not more than 4.5 μm.

5. The apparatus according to claim 1, wherein the plurality of pixels of the sensor substrate have a sensor size from ½-type to 1-type.

6. A display apparatus comprising the apparatus according to claim 1,
wherein the pixel circuit substrate includes an allocation unit that allocates the plurality of pixels of the sensor substrate to a first pixel region including at least the first region and a second pixel region including at least the second region,
the apparatus further includes a first conversion unit that converts the pixel signals into first video data of pixel signals from the first pixel region and second video data of pixel signals from the second pixel region, and
the first conversion unit outputs the first video data and the second video data at mutually different frame rates.

7. A display apparatus comprising the apparatus according to claim 2,
wherein the pixel circuit substrate includes an allocation unit that allocates the plurality of pixels of the sensor substrate to a first pixel region including at least the first region and a second pixel region including at least the second region,
the apparatus further includes a first conversion unit that converts the pixel signals into first video data of pixel signals from the first pixel region and second video data of pixel signals from the second pixel region, and
the first conversion unit outputs the first video data and the second video data at mutually different frame rates.

8. A display apparatus comprising the apparatus according to claim 3,
wherein the pixel circuit substrate includes an allocation unit that allocates the plurality of pixels of the sensor substrate to a first pixel region including at least the first region and a second pixel region including at least the second region,
the apparatus further includes a first conversion unit that converts the pixel signals into first video data of pixel signals from the first pixel region and second video data of pixel signals from the second pixel region, and
the first conversion unit outputs the first video data and the second video data at mutually different frame rates.

9. A display apparatus comprising the apparatus according to claim 4,
wherein the pixel circuit substrate includes an allocation unit that allocates the plurality of pixels of the sensor substrate to a first pixel region including at least the first region and a second pixel region including at least the second region,
the apparatus further includes a first conversion unit that converts the pixel signals into first video data of pixel signals from the first pixel region and second video data of pixel signals from the second pixel region, and
the first conversion unit outputs the first video data and the second video data at mutually different frame rates.

10. The display apparatus according to claim 6, wherein the imaging unit includes a first unit that outputs, for a right eye of a user, a first video signal including the first video data and the second video data, and a second unit that outputs, for a left eye of the user, a second video signal including the first video data and the second video data,
the display apparatus further comprised:
a second conversion unit that converts the first video signal output from the first unit into a first parallax video signal for the right eye and converts the second video signal output from the second unit into a second parallax video signal for the left eye;
a display panel configured to display, to the right eye and the left eye, respectively, video using the first parallax video signal and the second parallax video signal converted by the second conversion unit; and
a display driver that drives the display panel,
wherein the display driver updates pixels corresponding to the first region and the second region of the display panel at different frame rates.

11. The display apparatus according to claim 10, wherein the first unit and the second unit output the first video data and the second video data in parallel.

12. The display apparatus according to claim 10, wherein the second conversion unit outputs, in parallel, parallax video signals corresponding to the first video data and the second video data derived from the first parallax video signal, and outputs, in parallel, parallax video signals corresponding to the first video data and the second video data derived from the second parallax video signal.

13. The display apparatus according to claim 6, further comprising a line-of-sight detection unit that detects a line of sight of a user,
wherein the allocation unit changes a position of the second pixel region in accordance with a change in the detected line of sight.

14. The display apparatus according to claim 6, wherein the first pixel region and the second pixel region are arranged to be inscribed in, circumscribed about, or disposed inside of an image circle of the lens unit having Φ8 mm to Φ16 mm.

15. The display apparatus according to claim 7, further comprising a line-of-sight detection unit that detects a line of sight of a user,
wherein the allocation unit changes a position of the second pixel region in accordance with a change in the detected line of sight.

16. The display apparatus according to claim 7, wherein the first pixel region and the second pixel region are arranged to be inscribed in, circumscribed about, or disposed inside of an image circle of the lens unit having Φ8 mm to Φ16 mm.

17. The display apparatus according to claim 8, further comprising a line-of-sight detection unit that detects a line of sight of a user,
wherein the allocation unit changes a position of the second pixel region in accordance with a change in the detected line of sight.

18. The display apparatus according to claim 8, wherein the first pixel region and the second pixel region are arranged to be inscribed in, circumscribed about, or disposed inside of an image circle of the lens unit having Φ8 mm to Φ16 mm.

19. The display apparatus according to claim 9, further comprising a line-of-sight detection unit that detects a line of sight of a user,
wherein the allocation unit changes a position of the second pixel region in accordance with a change in the detected line of sight.

20. The display apparatus according to claim 9, wherein the first pixel region and the second pixel region are arranged to be inscribed in, circumscribed about, or disposed inside of an image circle of the lens unit having Φ8 mm to Φ16 mm.
